(19) United States
(12) Patent Application Publication
(10) Pub. No.: US 2023/0420712 A1
(43) Pub. Date: Dec. 28, 2023

(54) PRESSURIZED FUEL CELL COOLING SYSTEM

(71) Applicant: FORD GLOBAL TECHNOLOGIES, LLC, Dearborn, MI (US)

(72) Inventors: Jan MEHRING, Koeln (DE); Stefan KAIMER, Aachen (DE); Hans Guenter QUIX, Herzogenrath (DE); Monika DERFLINGER, Neidlingen (DE); Julio OROZCO SANTOS COY, Aachen (DE)

(73) Assignee: FORD GLOBAL TECHNOLOGIES, LLC, Dearborn, MI (US)

(21) Appl. No.: 18/314,296

(22) Filed: May 9, 2023

(30) Foreign Application Priority Data
May 19, 2022 (DE) 102022112560.2

(51) Int. Cl. H01M 8/04746; H01M 8/04029

(52) U.S. Cl. CPC H01M 8/04768; H01M 8/04029; H01M 2250/20; B60L 50/70

(57) ABSTRACT

A fuel cell system includes a fuel cell, a cooling system fluidly coupled to the fuel cell and having a heat exchanger, a coolant pump, and a coolant reservoir fluidly coupled to the heat exchanger and the coolant pump, a supply system configured to supply a gas containing oxygen to the fuel cell, and a valve positioned in a connecting line between the cooling system and the supply system, the valve operable to limit a pressure difference between pressure of the gas supplied to the fuel cell and pressure within the cooling system.

### CROSS-REFERENCE TO RELATED APPLICATIONS

This application claims foreign priority benefits under 35 U.S.C. § 119(a)-(d) to DE Application 10 2022 112 560.2 filed May 19, 2022, which is hereby incorporated by reference in its entirety.

### TECHNICAL FIELD

The disclosure relates to a fuel cell system having at least one fuel cell, at least one cooling device for cooling the fuel cell and at least one supply device for supplying a gas containing oxygen to the fuel cell. The disclosure also relates to a method for cooling a fuel cell system, which has at least one fuel cell.

### BACKGROUND

To ensure durability of a fuel cell, a pressure difference between a gas side, via which a gas containing oxygen is supplied to the fuel cell, and a coolant side, via which a coolant is supplied to the fuel cell, should be limited to a maximum limit value. In modern-day cooling systems for cooling a fuel cell, the maximum pressure level of the cooling system is conventionally limited by a pressure limiting value in the fill cover of an equalizing reservoir. However, the minimum pressure level is not usually limited. At low coolant temperatures, the pressure level in the equalizing reservoir may be below 1 bar. A pressure level of the coolant at the inlet of the fuel cell may be determined by taking into account the above-mentioned pressure level of the equalizing reservoir and a hydraulic pressure increase through a coolant pump of the cooling system. The coolant pressure level at the inlet of the fuel cell therefore depends on the system pressure in the equalizing reservoir and the rise in pressure caused by the coolant pump. This necessarily leads to different pressure levels at the inlet of the fuel cell.

DE102019217567A1 relates to a fuel cell system having at least one fuel cell stack, an oxygen supply, an exhaust gas path, a fuel supply and a cooling circuit, wherein the cooling circuit has a heat exchanger, a coolant pump and an equalizing reservoir. A connecting line is arranged between the equalizing reservoir and a branch point of the exhaust gas path, the connecting line having a means for flow-rate control.

U.S. Pat. No. 6,905,792B2 discloses a cooling system for a fuel cell, which traps bubbles in a coolant and protects a stack and the membrane of a humidifier by managing the coolant pressure of the fuel cell. The cooling system moreover prevents foreign substances from mixing into the coolant.

U.S. Pat. No. 7,494,730B2 discloses a device for cooling a fuel cell, wherein a cooling fluid circulates between the fuel cell and a heat exchanger. The cooling device separates the gas introduced into the cooling fluid, mixes the separated gas with the air supplied to the fuel cell or discharged from the fuel cell and then discharges the gas.

US2007026267A1 discloses a method for cooling a fuel cell system having a fuel cell, which has an anode chamber, to which a gas containing hydrogen is supplied, and a cathode chamber, to which a gas containing oxygen is supplied via an air intake system. A cooling device is arranged at least in the fuel cell, which cooling device is part of a cooling circuit in which a liquid coolant is moved. In the cooling circuit, gaseous constituents contained in the liquid coolant are liberated outside the fuel cell and supplied to the air intake system via a bypass channel, which does not contain an ignition source for an ignitable gas mixture.

US2009269639A1 discloses a product having a coolant tank reservoir for fuel cells, which has an opening and a pressure relief valve which is designed and arranged such that it is in a closed position when the pressure in the tank is lower than a first pressure and is in an open position when the pressure in the tank exceeds the first pressure. A cooling fluid line is wound around a portion of the pressure relief valve in order to heat it.

US2009087708A1 discloses a fuel cell system having a pressurizing valve, which is provided on a cooling water circulation path, a storage reservoir, into which the cooling water flows through a pipe when the pressure valve is open, an air supply pipe, which is connected to the storage tank in order to supply air for diluting a combustion gas when the combustion gas accumulates in the storage tank, and an exhaust gas pipe for diluted gas for discharging the diluted combustion gas from the storage tank.

### SUMMARY

According to one embodiment of the claimed subject matter a fuel cell system has at least one limiting device for limiting a pressure difference between the pressure with which the gas can be supplied to the fuel cell by means of the supply device and a pressure with which a coolant can be supplied to the fuel cell by means of the cooling device to a predetermined upper limit value.

It should be pointed out that the features and measures listed individually in the description below may be combined with one another in any technically meaningful manner and demonstrate further configurations of the invention. The description additionally characterizes and specifies the invention in particular in conjunction with the figures.

In one or more embodiments, the pressure difference between the pressure with which the gas can be supplied to the fuel cell by means of the supply device and the pressure with which a coolant can be supplied to the fuel cell by means of the cooling device is automatically limited to a predetermined upper limit value by the limiting device. In this way, better durability of the fuel cell and therefore the entire fuel cell system is provided since pressure differences between the gas and coolant above the predetermined limit value would significantly impair the fuel cell or the durability thereof. In one embodiment, the upper limit value may be in a range of 1 bar to 2 bar, for example. In another embodiment, the upper limit value is less than 2 bar, for example. In another embodiment, the upper limit value is less than 1 bar.

The limiting device may be an active, for example electronic, or passive limiting device. An active limiting device may have at least one pressure sensor for detecting the pressure with which the gas can be supplied to the fuel cell by means of the supply device, at least one pressure sensor for detecting the pressure with which the coolant can be supplied to the fuel cell by means of the cooling device, at least one evaluation electronics system for comparing the detected pressure values or for ascertaining the pressure difference between the detected pressure values, and at least one electrically activatable unit for influencing the respective pressure or both pressures together. The pressure difference may be ascertained for example from a difference d_{Gas}−d_{Coolant}, where d_{Gas} is the pressure with which the gas can be supplied to the fuel cell by means of the supply device and d_{Coolant} is the pressure with which the coolant can be supplied to the fuel cell by means of the cooling device. The evaluation electronics may moreover be designed to compare the ascertained pressure difference to a stored predetermined upper limit value and to activate the electrically activatable unit to limit the pressure difference if the pressure difference would otherwise exceed the predetermined upper limit value.

The cooling device for cooling the fuel cell may have a coolant circuit, which has at least one heat exchanger, in particular cooler, through which coolant circulating in the coolant circuit flows by means of a coolant pump of the coolant circuit. The coolant circuit may moreover have an equalizing reservoir for equalizing a coolant pressure within the coolant circuit.

The supply device for supplying the gas containing oxygen to the fuel cell may have at least one electric-motor-driven compressor for supplying a pressurized gas to the fuel cell. The compressor may be connected to the fuel cell via at least one supply line of the supply device.

The gas which can be supplied to the fuel cell may be air, for example. A fuel can moreover be supplied to the fuel cell, which fuel may be hydrogen, for example, or may contain hydrogen. The fuel cell system may also have two or more fuel cells, in particular assembled to form a fuel cell stack, which can be cooled together by means of the cooling device. The fuel cell system may be installed in an electrically driven motor vehicle, for example, to generate electrical energy.

According to an advantageous configuration, the cooling device has at least one equalizing reservoir and the limiting device has at least one electrically activatable solenoid valve which can be used to set a pressure within the equalizing reservoir. The solenoid valve may therefore be used to actively manage the pressure level in the equalizing reservoir. The limiting device here is designed as an active limiting device, as is described above. The solenoid valve may have two switching positions, the solenoid valve being closed in the first switching position and open in the other switching position to release air contained in the equalizing reservoir.

According to a further advantageous configuration, the cooling device has at least one equalizing reservoir and the limiting device has at least one connecting line, via which a supply line—leading into the fuel cell—of the supply device is connected to the equalizing reservoir. This configuration represents a passive configuration of the limiting device. The pressure in the equalizing reservoir is held at the pressure level in the supply line via the connecting line, which reliably prevents a pressure difference between these pressures which would impair the durability of the fuel cell.

According to a further configuration, the limiting device has at least one non-return valve, which is arranged at the connecting line and opens when a pressure in the supply line exceeds a pressure in the equalizing reservoir by a predetermined minimum limit value. In this way, pressure equalization may take place only in the direction of the equalizing reservoir, but not in the direction of the supply line. This configuration also represents a passive configuration of the limiting device. The non-return valve may prevent coolant from the cooling device making its way into the supply line via the connecting line. A minimum pressure difference for the pressure equalization may moreover be specified via a spring stiffness of a spring element of the non-return valve.

According to a further advantageous configuration, the limiting device has at least one pressure intensifier, which is arranged at the connecting line and with which the pressure in the equalizing reservoir can be kept higher than the pressure in the supply line. In this way, the pressure in the equalizing reservoir may be kept at a higher level than the pressure in the supply line, which may be advantageous if it is desired that the coolant pressure at the fuel cell inlet be higher than the pressure of the gas supplied to the fuel cell. This configuration represents a likewise passive configuration of the limiting device.

According to a further advantageous configuration, the limiting device has at least one electrically activatable solenoid valve, which is arranged at the connecting line. This configuration represents a configuration of an active limiting device, as is described above. Via the solenoid valve, the connecting line may be closed in a closed position of the solenoid valve and opened in an open position of the solenoid valve.

In another advantageous configuration, a method includes automatically controlling or limiting a pressure difference between a pressure with which a gas containing oxygen is supplied to the fuel cell and a pressure with which a coolant is supplied to the fuel cell to a predetermined upper limit value.

The advantages mentioned above in relation to the fuel cell system are associated accordingly with the method. In particular, the fuel cell system according to one of the above-mentioned configurations or a combination of at least two of these configurations together may be used to carry out the method.

According to an advantageous configuration, the pressure difference is limited by setting a pressure within an equalizing reservoir of a cooling device of the fuel cell system. The advantages mentioned above in relation to the corresponding configuration of the fuel cell system are associated accordingly with this configuration. In particular, the pressure within the equalizing reservoir may be set via an electrically activatable solenoid valve connected to the equalizing reservoir.

According to a further advantageous configuration, the pressure difference is limited by connecting an equalizing reservoir of a cooling device of the fuel system to a supply line—leading into the fuel cell—of a supply device of the fuel cell system via at least one connecting line, which supply device is used to supply a gas containing oxygen to the fuel cell. The advantages mentioned above in relation to the corresponding configuration of the fuel cell system are associated accordingly with this configuration.

According to a further advantageous configuration, the pressure difference is limited via at least one non-return valve, which is arranged at the connecting line and which opens when a pressure in the supply line exceeds a pressure in an equalizing reservoir of a cooling device of the fuel cell system by a predetermined minimum limit value, which cooling device is used to cool the fuel cell. The advantages mentioned above in relation to the corresponding configuration of the fuel cell system are associated accordingly with this configuration.

According to a further advantageous configuration, the pressure difference is limited using at least one pressure intensifier, which is arranged at the connecting line and with which the pressure in the equalizing reservoir can be kept higher than the pressure in the supply line. The advantages mentioned above in relation to the corresponding configuration of the fuel cell system are associated accordingly with this configuration.

According to a further advantageous configuration, the pressure difference is limited via at least one electrically activatable solenoid valve, which is arranged at the connecting line. The advantages mentioned above in relation to the corresponding configuration of the fuel cell system are associated accordingly with this configuration.

### BRIEF DESCRIPTION OF THE DRAWINGS

FIG. 1 shows a schematic illustration of an embodiment of a fuel cell system.

FIG. 2 shows a schematic illustration of another embodiment of a fuel cell system.

FIG. 3 shows a schematic illustration of a further embodiment of a fuel cell system.

FIG. 4 shows a schematic illustration of another embodiment of a fuel cell system.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter. In the different figures, equivalent parts are denoted by the same reference signs and are therefore generally described only once.

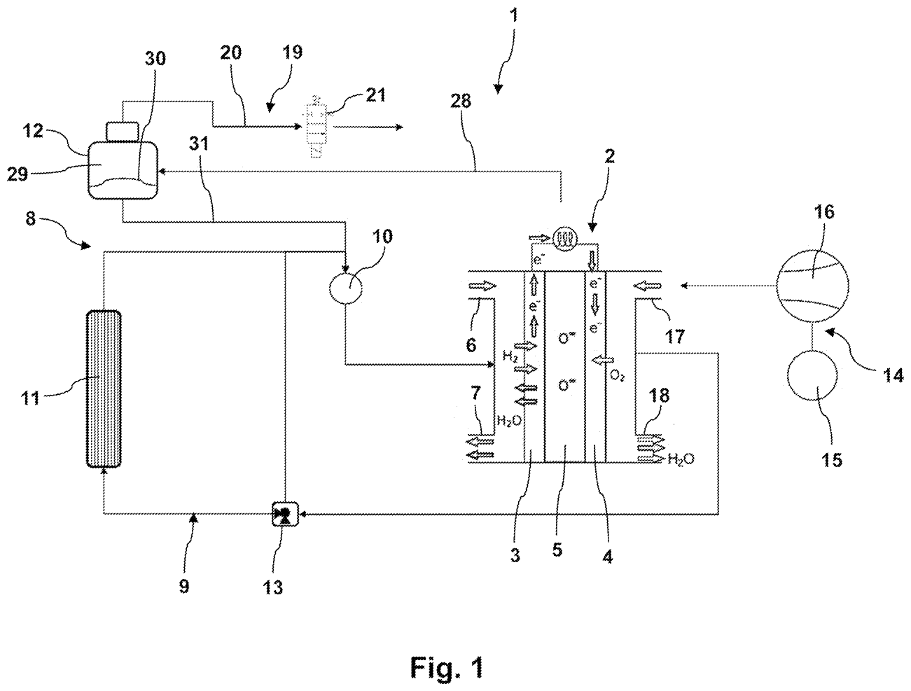

FIG. 1 shows a schematic illustration of an embodiment of fuel cell system 1 according to the disclosure. The fuel cell system 1 has a fuel cell 2 having an anode 3, a cathode 4 and an electrolyte 5 arranged between them. A fuel, in this case hydrogen, is supplied to the fuel cell via a fuel feed line 6. Excess fuel and water are discharged from the fuel cell 2 via an exhaust gas line 7.

The fuel cell system 1 moreover has a cooling system 8 for cooling the fuel cell 2. To this end, the cooling system 8 has a coolant circuit 9, to which the fuel cell 2 is connected and in which a coolant can be circulated by means of a coolant pump 10 of the coolant circuit 9. The cooling system 8 has a heat exchanger or cooler 11, connected to the coolant circuit 9, and an equalizing reservoir 12, connected to the coolant circuit 9. The coolant circuit 9 moreover has a switchable valve 13, via which a coolant flow can be optionally guided through the cooler 11 or through a bypass line. The latter may take place if the temperature of the coolant is below a desired operating temperature. The valve 13 may be designed as a thermostat.

The fuel cell system 1 moreover has a supply device 14 for supplying a gas containing oxygen, in this case air, to the fuel cell 2. The supply device 14 has a compressor 16, which can be driven by an electric motor 15, and a supply line 17 for supplying the gas to the fuel cell 2. Unused gas may be discharged from the fuel cell via an outlet line 18.

The fuel cell system 1 furthermore has a limiting device 19 for limiting a pressure difference between the pressure with which the gas can be supplied to the fuel cell 2 by means of the supply device 14 and a pressure with which the coolant can be supplied to the fuel cell 2 by means of the cooling system 8 to a predetermined upper limit value. The limiting device 19 has an electrically activatable solenoid valve 21, which is connected to the equalizing reservoir 12 via a release line 20 and which can be used to set a pressure within the equalizing reservoir 12.

The fuel cell system 1 moreover has a vent line 28, which is connected to the fuel cell 2 at one end and to the equalizing reservoir 12 at the other. The vent line 28 here leads from a local highest point (not shown) of the coolant circuit 9, which may be formed, for example, by a hose (not shown) or a cooling component (not shown) of the coolant circuit 9, to a gas region 29 of the equalizing reservoir 12 which is arranged higher than the local highest point, i.e. to a region 29 of the equalizing reservoir 12 which is arranged above a coolant level 30 within the equalizing reservoir 12. The equalizing reservoir 12 is connected to an inlet of the coolant pump 10 via a return line 31, so that the pressure in the equalizing reservoir 12 corresponds to the lowest pressure level in the cooling system 8.

A pressure p_{Cell}=p_{AB}+p_{Pump} is applied at a coolant inlet (not shown) of the fuel cell 2, where p_{AB} is the pressure within the equalizing reservoir 12 and p_{Pump} is the pressure generated by the coolant pump 10 in each case, where the latter may be between 0 bar and 1.5 bar. By means of the compressor 16, a pressure p_{Gas} may be generated which may be between 1.2 bar and 2 bar, for example.

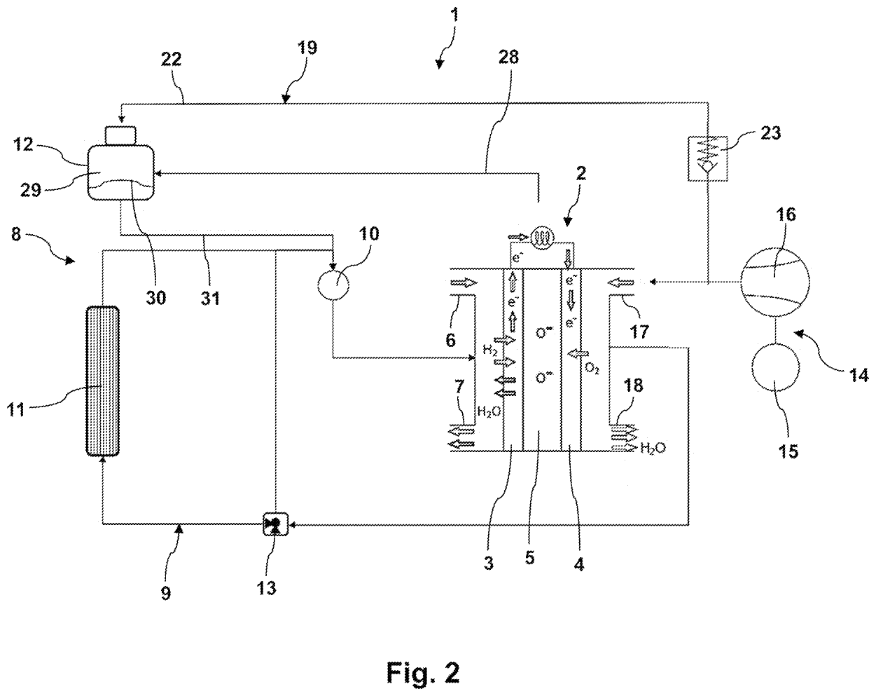

FIG. 2 shows a schematic illustration of a further embodiment of a fuel cell system 1. The fuel cell system differs from the embodiment shown in FIG. 1 in that, instead of the solenoid valve, the limiting device 19 has a connecting line 22, via which the supply line 17—leading into the fuel cell 2—of the supply device 14 is connected to the equalizing reservoir 12, and a non-return valve 23, which is arranged at the connecting line 22 and which opens when a pressure in the supply line 17 exceeds a pressure in the equalizing reservoir 12 by a predetermined minimum limit value. Reference is moreover made to the above description relating to FIG. 1 for additional details.

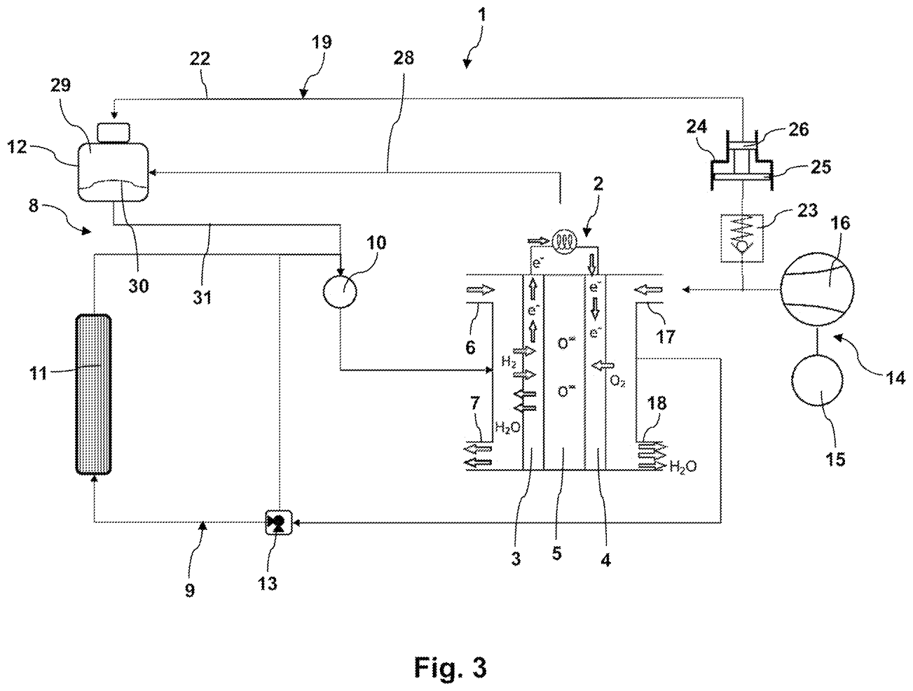

FIG. 3 shows a schematic illustration of a further embodiment of a fuel cell system 1. The fuel cell system differs from the embodiment shown in FIG. 2 in that the limiting device 19 additionally has a pressure intensifier 24, which is arranged at the connecting line 22 and with which the pressure in the equalizing reservoir 12 is kept higher than the pressure in the supply line 17. The pressure in the equalizing reservoir here is p_{AB}=p_{Z}·A₁/A₂, where p_{Z} is the pressure in the supply line 17, A₁ is a piston area of a first piston 25 of the pressure intensifier 24 and A₂ is a piston area of a second piston 26 of the pressure intensifier 24. Reference is moreover made to the above description relating to FIGS. 1 and 2 for additional details.

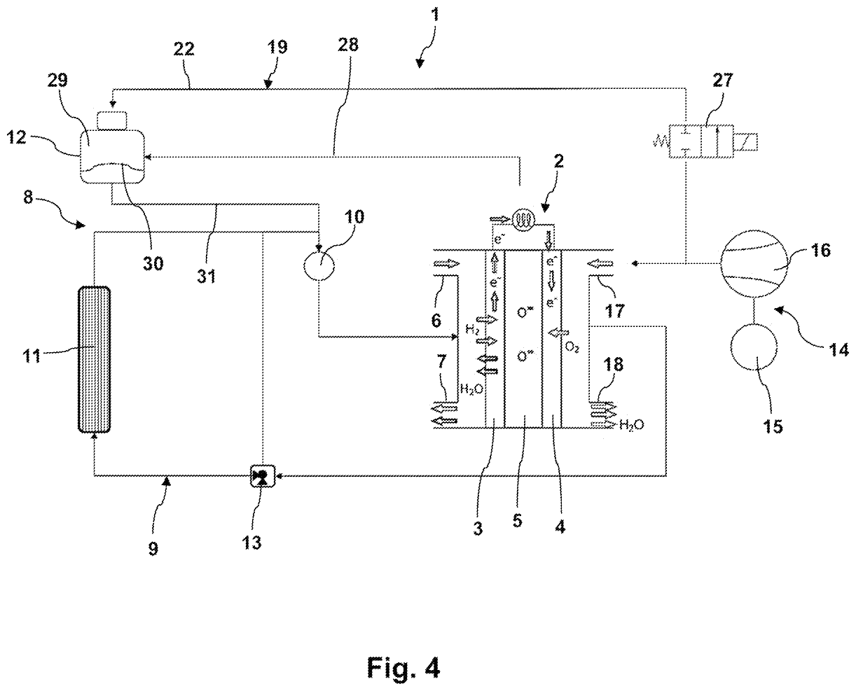

FIG. 4 shows a schematic illustration of a further embodiment of a fuel cell system 1. The fuel cell system differs from the embodiment shown in FIG. 2 in that, instead of the non-return valve, the limiting device 19 has an electrically activatable solenoid valve 27, which is arranged at the connecting line 22. Reference is moreover made to the above description relating to FIGS. 1 and 2 for additional details.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. A fuel cell system comprising:
a fuel cell;
a cooling system fluidly coupled to the fuel cell, comprising:
a heat exchanger;
a coolant pump; and
a coolant reservoir fluidly coupled to the heat exchanger and the coolant pump;
a supply system configured to supply a gas containing oxygen to the fuel cell; and
a valve positioned in a connecting line between the cooling system and the supply system, the valve operable to limit a pressure difference between pressure of the gas supplied to the fuel cell and pressure within the cooling system.

2. The fuel cell system of claim 1 wherein the valve comprises a solenoid valve.

3. The fuel cell system of claim 2 wherein the solenoid valve is operable by a vehicle controller in response to the pressure difference.

4. The fuel cell system of claim 1 further comprising a compressor operable to compress the gas supplied to the fuel cell, wherein the valve is positioned in the connecting line between the coolant reservoir and an outlet of the compressor.

5. The fuel cell system of claim 4 wherein the valve comprises a passive non-return valve that opens when pressure at the outlet of the compressor exceeds pressure in the coolant reservoir by a predetermined minimum limit value.

6. The fuel cell system of claim 5 further comprising a pressure intensifier positioned between the coolant reservoir and the passive non-return valve.

7. The fuel cell system of claim 6 wherein the pressure intensifier is configured to maintain pressure in the coolant reservoir at a higher pressure than pressure at the outlet of the compressor.

8. The fuel cell system of claim 4 wherein the valve comprises a solenoid valve.

9. A fuel cell system comprising:
a fuel cell;
a cooling system fluidly coupled to the fuel cell, comprising:
a heat exchanger;
a coolant pump; and
a coolant reservoir fluidly coupled to the heat exchanger and the coolant pump;
a compressor configured to supply a compressed gas containing oxygen to the fuel cell; and
a valve positioned in a connecting line coupled to the coolant reservoir, the valve operable to limit a pressure difference between pressure of the compressed gas supplied to the fuel cell and pressure within the coolant reservoir.

10. The fuel cell system of claim 9 wherein the valve comprises a solenoid valve.

11. The fuel cell system of claim 10 wherein the connecting line connects the coolant reservoir to an outlet of the compressor.

12. The fuel cell system of claim 9 wherein the connecting line connects the coolant reservoir to an outlet of the compressor and the valve comprises a passive non-return valve.

13. The fuel cell system of claim 12 wherein the passive non-return valve opens when pressure at the outlet of the compressor exceeds pressure in the coolant reservoir by a predetermined minimum limit value.

14. The fuel cell system of claim 13 further comprising a pressure intensifier positioned between the coolant reservoir and the passive non-return valve.

15. The fuel cell system of claim 14 wherein the pressure intensifier is configured to maintain pressure in the coolant reservoir at a higher pressure than pressure at the outlet of the compressor.

16. The fuel cell system of claim 15 wherein the pressure intensifier comprises a first piston having a first area fluidly coupled to the passive non-return valve and a second piston connected to the first piston and having a second area fluidly coupled to the coolant reservoir, wherein the first area is larger than the second area.

17. A fuel cell system comprising:
a fuel cell;
a cooling system fluidly coupled to the fuel cell, comprising:
a heat exchanger;
a coolant pump; and
a coolant reservoir fluidly coupled to the heat exchanger and the coolant pump;
a compressor configured to supply a compressed gas containing oxygen to the fuel cell; and
a valve positioned in a connecting line between the coolant reservoir and an outlet of the compressor, the valve operable to limit a pressure difference between pressure of the compressed gas supplied to the fuel cell and pressure within the coolant reservoir.

18. The fuel cell system of claim 17 wherein the valve comprises a solenoid valve.

19. The fuel cell system of claim 17 wherein the valve comprises a passive non-return valve that opens when pressure at the outlet of the compressor exceeds pressure in the coolant reservoir by a predetermined minimum limit value.

20. The fuel cell system of claim 19 further comprising a pressure intensifier positioned within the connecting line, the pressure intensifier comprising a first piston having a first area fluidly coupled to the passive non-return valve and a second piston connected to the first piston and having a second area fluidly coupled to the coolant reservoir, wherein the first area is larger than the second area.
